(19) United States
(12) Patent Application Publication
(10) Pub. No.: US 2004/0130373 A1
(43) Pub. Date: Jul. 8, 2004

(54) Low-swing impedance controlled unity gain differential clock driver

(76) Inventor: Aninda K. Roy, San Jose, CA (US)

Correspondence Address: OSHA & MAY L.L.P./SUN, 1221 MCKINNEY, SUITE 2800, HOUSTON, TX, 77010, US

(21) Appl. No.: 10/338,229

(22) Filed: Jan. 8, 2003

(51) Int. Cl. G06F 1/04

(52) U.S. Cl. 327/295

(57) ABSTRACT

A method and apparatus for driving a differential clock signal involves a first power supply, second power supply, first clock path, and second clock path. The differential clock driver is arranged to receive a differential clock signal from the first clock path and generate a differential clock signal on the second clock path. The generated differential clock signal has a maximum voltage potential less than a maximum voltage potential of the first power supply voltage potential and a minimum voltage potential greater than a minimum voltage potential of the second power supply voltage potential.

### BACKGROUND OF INVENTION

As shown in FIG. 1, a typical computer system (10) has, among other components, a microprocessor (12), one or more forms of memory (14), integrated circuits (16) having specific functionalities, and peripheral computer resources (not shown), e.g., monitor, keyboard, software programs, etc. These components communicate with one another via communication paths (19), e.g., wires, buses, etc., to accomplish the various tasks of the computer system (10).

In order to properly accomplish such tasks, the computer system (10) relies on the basis of time to coordinate its various operations. To that end, a crystal oscillator (18) generates a system clock signal (referred to and known in the art as “reference clock” and shown in FIG. 1 as SYS_CLK) to various parts of the computer system (10). Modern microprocessors and other integrated circuits, however, are typically capable of operating at frequencies significantly higher than the system clock signal, and thus, it becomes important to ensure that operations involving the microprocessor (12) and the other components of the computer system (10) use a proper and accurate reference of time.

One component used within the computer system (10) to ensure a proper reference of time among the system clock signal and a microprocessor clock signal, i.e., “chip clock signal” or CHIP_CLK, is a type of clock generator known as a phase locked loop (PLL) (20). The PLL (20) is an electronic circuit that controls an oscillator such that the oscillator maintains a constant phase relative to the system clock signal. Referring to FIG. 1, the PLL (20) has as its input the system clock signal, which is its reference signal, and outputs a chip clock signal (shown in FIG. 1 as CHIP_CLK) to the microprocessor (12). The system clock signal and chip clock signal have a specific phase and frequency relationship controlled by the PLL (20). This relationship between the phases and frequencies of the system clock signal and chip clock signal ensures that the various components within the microprocessor (12) use a controlled and accounted for reference of time. When this relationship is not maintained by the PLL (20), however, the operations within the computer system (10) become non-deterministic.

FIG. 2 shows a block diagram of a typical phase locked loop and clock tree (200). The phase locked loop (202) receives a clock signal from clock path (201). The phase locked loop (202) outputs a clock signal on clock path (203). The clock signal on clock path (203) may have an increased frequency compared to the frequency of the clock signal on clock path (201). The phase locked loop (202) drives the clock signal on clock path (203) so that the clock signal on clock path (203) may connect to other circuits using the clock tree (200).

The clock tree (200) includes many impedances caused by the physical routing of clock tree wires. Impedances (230, 232, 234, 236, 238, 240, 242, 244, 246, 248, 250) may delay and/or attenuate the clock signal on clock path (203). The phase locked loop (202) receives an input clock signal from part of the clock tree (200) formed by the clock signal on clock path (203). Accordingly, the phase locked loop (202) may adjust the timing and frequency of the clock signal on clock path (203) to compensate for some of the effects caused by the impedances (230,232, 234, 236, 238, 240, 242, 244, 246, 248, 250).

FIG. 3 shows a block diagram of a typical phase locked loop and buffered clock tree (300). As in FIG. 2, the phase locked loop (302) receives a clock signal from clock path (301). The phase locked loop (302) outputs a clock signal on clock path (303). The clock signal on clock path (303) may have an increased frequency compared to the frequency of the clock signal on clock path (301). The phase locked loop (302) drives the clock signal on clock path (303) so that the clock signal on clock path (303) may connect to other circuits using the clock tree (300). For example, circuits (324, 364) are responsive to a buffered copy of the clock signal on clock path (303).

The clock tree (300) may have impedances (not shown) that delay and/or attenuate the clock signal on clock path (303). The phase locked loop (302) may not be able to adequately drive the clock signal on clock path (303) so that other circuits using a clock tree operate properly. Accordingly, drivers (304, 306, 320, 322, 344, 346, 360, 362) may be disposed along the clock tree to buffer the clock signal on clock path (303).

The phase locked loop (302) receives an input clock signal from part of the clock tree. For example, clock signal on clock path (363) may be input to the phase locked lop (302). Accordingly, the phase locked loop (302) may adjust the timing and frequency of the clock signal on clock path (303) to compensate for some of the effects caused by the impedances (not shown).

The drivers (304, 306, 320, 322) and the drivers (344, 346, 360, 362) form two different branches of the clock tree (300). Differences in the propagation delay from the clock signal on clock path (303) to a clock signal on clock path (323) compared to the clock signal on clock path (303) to a clock signal on clock path (363) may exist. The differences may be caused by variation in the manufacture of the clock tree (300) and changes in the drivers (304, 306, 320, 322, 344, 346, 360, 362) due to temperature, voltage, power supply noise, and/or switching noise. Accordingly, the timing of the circuits (324, 364) may not be the same. Different slew rates between the drivers (304, 306, 320, 322, 344, 346, 360, 362), different path lengths from the clock signal on clock path (303) to a clock signal on clock path (323) compared to the clock signal on clock path (303) to a clock signal on clock path (363), and clock jitter exacerbate problems associated with circuit timings.

### SUMMARY OF INVENTION

According to one aspect of the present invention, a

According to another aspect of the present invention, a

According to another aspect of the present invention, an

Other aspects and advantages of the invention will be apparent from the following description and the appended claims.

### BRIEF DESCRIPTION OF DRAWINGS

FIG. 1 shows a block diagram of a typical computer system.

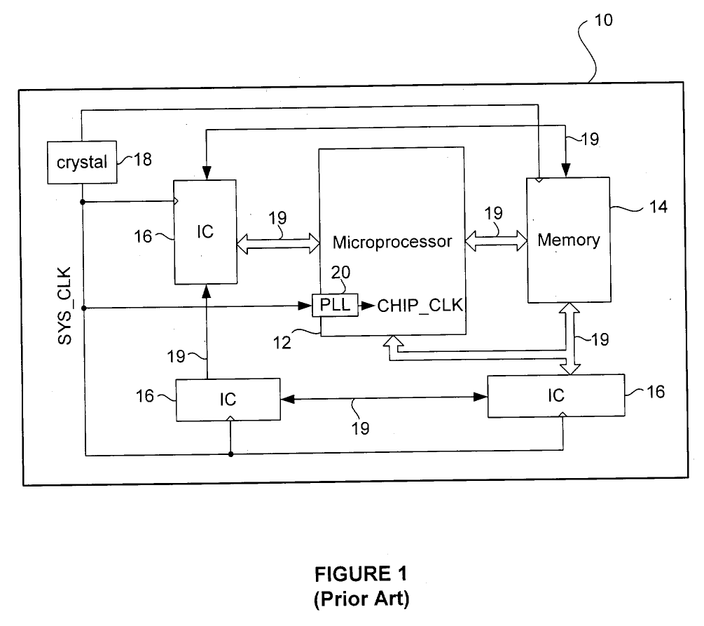

FIG. 2 shows a block diagram of a typical phase locked loop and clock tree.

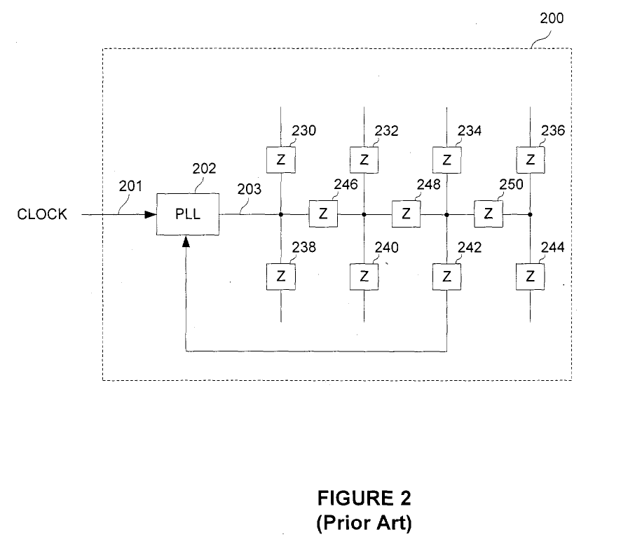

FIG. 3 shows a block diagram of a typical phase locked loop and buffered clock tree.

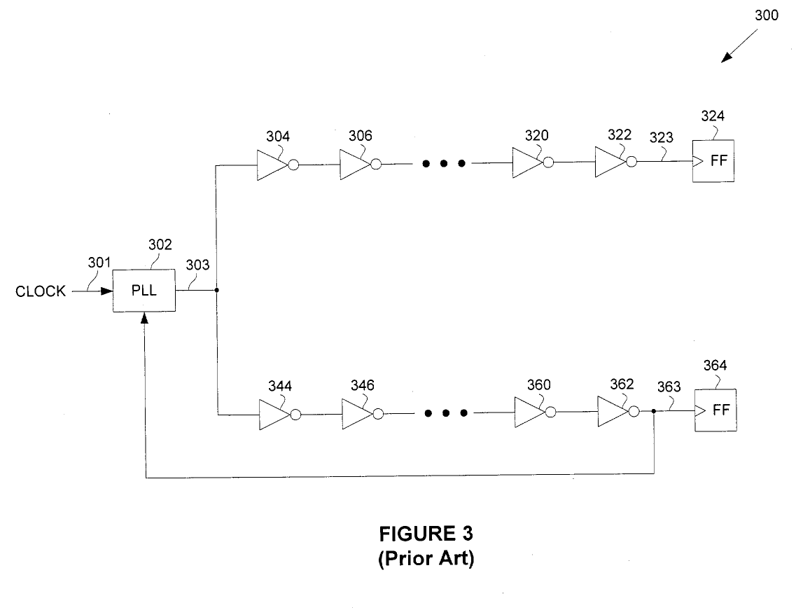

FIG. 4 shows a block diagram of a phase locked loop and a low-swing differential clock tree in accordance with an embodiment of the present invention.

FIG. 5 shows a block diagram of a low-swing impedance controlled unity gain differential clock driver in accordance with an embodiment of the present invention.

### DETAILED DESCRIPTION

Embodiments of the present invention relate to a unity gain differential clock driver. In one or more embodiments, the unity gain differential clock driver is arranged to receive and generate a differential clock signal. The generated differential clock signal has a voltage potential in between voltage potentials that supply power to the differential clock driver.

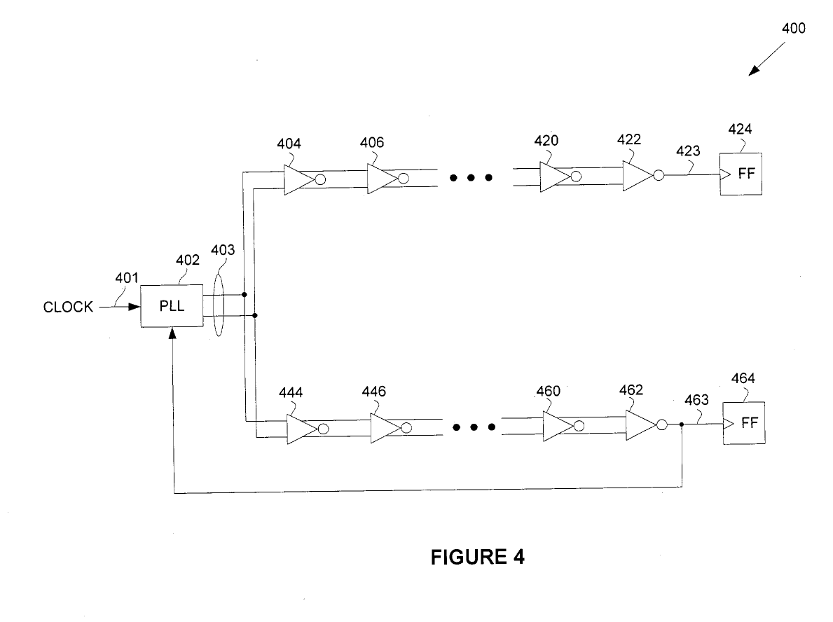

In FIG. 4, a block diagram of an exemplary phase locked loop and a low-swing differential clock tree (400) in accordance with an embodiment of the present invention is shown. A phase locked loop (402) receives a clock signal from clock path (401). The phase locked loop (402) outputs a differential clock signal on differential clock path (403). A differential signal includes a clock signal and a complementary clock signal. The differential clock signal on differential clock path (403) may have an increased frequency compared to the frequency of the clock signal on clock path (401). The phase locked loop (402) drives the differential clock signal on differential clock path (403) so that the differential clock signal on differential clock path (403) may connect to other circuits using the clock tree (400). For example, circuits (424, 464) are responsive to a buffered copy of the differential clock signal on differential clock path (403).

The clock tree (400) may have impedances (not shown) that delay and/or attenuate the differential clock signal on differential clock path (403). The phase locked loop (402) may not be able to adequately drive the differential clock signal on differential clock path (403) so that other circuits using a clock tree operate properly. Accordingly, differential drivers (404, 406, 420, 444, 446, 460) and differential to single ended drivers (422, 462) may be disposed along the clock tree to buffer the differential clock signal on differential clock path (403).

The phase locked loop (402) receives an input clock signal from part of the clock tree (400). For example, clock signal on clock path (463) may be input to the phase locked lop (402). Accordingly, the phase locked loop (402) may adjust the timing and frequency of the differential clock signal on differential clock path (403) to compensate for some of the effects caused by the impedances (not shown).

The differential drivers (404, 406, 420) and differential to single ended driver (422) form a different branch of the clock tree than the differential drivers (444, 446, 460) and the differential to single ended driver (462). To reduce the effects of clock signal skew and clock signal jitter, the differential drivers (404, 406, 420, 444, 446, 460) are low-swing impedance controlled unity gain differential drivers.

The differential drivers (404, 406, 420, 444, 446, 460) output differential signals that have a voltage potential in between a power supply voltage potential that supplies the differential drivers (404, 406, 420, 444, 446, 460). Accordingly, the slew rate of the output differential signals from the differential drivers (404, 406, 420, 444, 446, 460) does not have to transition as quickly. Also, the differential drivers (404, 406, 420, 444, 446, 460) are arranged to have an impedance controlled unity gain. The impedance controlled unity gain will match a slew rate of the output differential signals to the slew rate of the inputs to the differential drivers (404, 406, 420, 444, 446, 460).

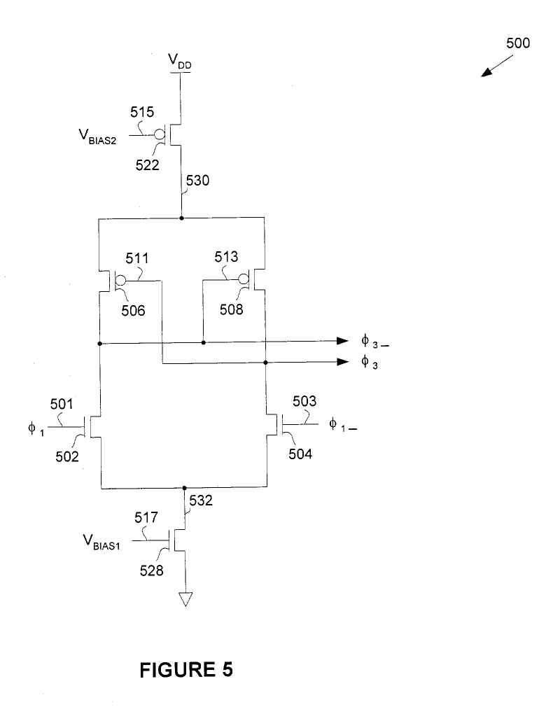

In FIG. 5, a block diagram of an exemplary low-swing impedance controlled unity gain differential clock driver (500) in accordance with an embodiment of the present invention is shown. The differential clock driver (500) includes a p-channel transistor (522) with a gate terminal connected to a control voltage V_{BIAS2} (515). Dependent on V_{BIAS2} (515), the p-channel transistor (522) causes a voltage potential on wire (530) less than the voltage potential of V_{DD}. The differential clock driver (500) includes an n-channel transistor (528) with a gate terminal connected to a control voltage V_{BIAS1} (517). Dependent on _{VBIAS1} (517), the n-channel transistor (528) causes a voltage potential on wire (532) greater than the voltage potential of V_{SS}.

In FIG. 5, n-channel transistors (502, 504) and p-channel transistors (506, 508) are arranged to form an impedance controlled unity gain differential amplifier. Differential input clock signals φ₁ and φ₁_{_{—}} on clock paths (501, 503) are received by n-channel transistors (502, 504), respectively. The n-channel transistors (502, 504) respond to the differential input clock signals φ₁ and φ₁_{_{—}} on clock paths (501, 503). One of the n-channel transistors (502, 504) will pull one of differential output clock signals φ₃ and φ₃_{_{—}} on clock paths (511, 513) to the voltage potential on wire (532). The differential output clock signals φ₃ and φ₃_{_{—}} on clock paths (511, 513) that is pulled to the voltage potential on wire (532) will turn on one of the p-channel transistors (506, 508). Accordingly, other differential output clock signals φ₃ and φ₃_{_{—}} on clock paths (511, 513) will be at the voltage potential on wire (530).

One of ordinary skill in the art will understand that a unity gain amplifier and an amplifier with a high open loop gain arranged as a unity gain amplifier provides a similar slew rate at the output of the unity gain amplifier as an input of the unity gain amplifier. Also, a reduced slew rate for a clock signal may be required by using a reduced voltage potential difference between the voltage potential rails of a clock signal. Furthermore, a higher frequency clock signal may be transmitted with a similar slew rate as a lower frequency clock signal by using a reduced voltage potential difference between the voltage potential rails of the higher frequency clock signal.

Advantages of the present invention may include one or more of the following. In one or more embodiments, because a low-swing differential clock driver is used, a reduced slew rate may be required.

In one or more embodiments, because a impedance controlled unity gain differential clock driver is used, a slew rate between an input clock signal and an output clock signal is similar.

In one or more embodiments, because a low-swing impedance controlled unity gain differential clock driver is used in a clock tree, clock signals on the clock tree may be resistant to variations in the manufacture of the clock tree and to the variations caused by temperature, voltage, power supply noise, and/or switching noise the effects.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus, comprising:
a first power supply path arranged to supply a first voltage potential;
a second power supply path arranged to supply a second voltage potential;
a first differential clock path arranged to propagate a first differential clock signal;
a second differential clock path arranged to propagate a second differential clock signal; and
a first differential clock driver arranged to drive the second differential clock signal responsive to the first differential clock signal, wherein a maximum voltage potential of the second differential clock signal is less than a maximum voltage potential of the first voltage potential, and wherein a minimum voltage potential of the second differential clock signal is greater than a minimum voltage potential of the second voltage potential.

2. The apparatus of claim 1, wherein the first differential clock driver is arranged as an impedance controlled unity gain differential clock driver.

3. The apparatus of claim 1, wherein the first differential clock driver comprises a first biased transistor to limit the maximum voltage potential of the second differential clock signal less than the maximum voltage potential of the first voltage potential.

4. The apparatus of claim 1, wherein the first differential clock driver comprises a second biased transistor to limit the minimum voltage potential of the second differential clock signal greater than the minimum voltage potential of the second voltage potential.

5. The apparatus of claim 1, wherein the first differential clock driver operatively connects to a phase locked loop.

6. The apparatus of claim 1, further comprising:
a third differential clock path arranged to propagate a third differential clock signal; and
a second differential clock driver arranged to drive the third differential clock signal responsive to the second differential clock signal, wherein a maximum voltage potential of the third differential clock signal is less than a maximum voltage potential of the first voltage potential, and a minimum voltage potential of the third differential clock signal is greater than a minimum voltage potential of the second voltage potential.

7. The apparatus of claim 6, wherein the second differential clock driver is arranged as a impedance controlled unity gain differential clock driver.

8. The apparatus of claim 6, wherein the second differential clock driver comprises a third biased transistor to limit the maximum voltage potential of the third differential clock signal less than the maximum voltage potential of the first voltage potential.

9. The apparatus of claim 6, wherein the second differential clock driver comprises a fourth biased transistor to limit the minimum voltage potential of the third differential clock signal greater than the minimum voltage potential of the second voltage potential.

10. The apparatus of claim 6, wherein the first differential clock driver and the second differential clock driver are part of a clock tree.

11. A method for propagating a differential clock signal in a clock tree having a first power supply voltage potential and a second power supply voltage potential, comprising:
inputting a first differential clock signal;
outputting a second differential clock signal dependent on the first differential clock signal; and
generating the second differential clock signal wherein a maximum voltage potential of the second differential clock signal is less than a maximum voltage potential of the first power supply voltage potential, and wherein a minimum voltage potential of the second differential clock signal is greater than a minimum voltage potential of the second power supply voltage potential.

12. The method of claim 11, wherein the generating the second differential clock signal uses an impedance controlled unity gain differential clock driver.

13. The method of claim 11, wherein the generating the second differential clock signal uses a first biased transistor to limit the maximum voltage potential of the second differential clock signal less than the maximum voltage potential of the first power supply voltage potential.

14. The method of claim 11, wherein the generating the second differential clock signal uses a second biased transistor to limit the minimum voltage potential of the second differential clock signal greater than the minimum voltage potential of the second power supply voltage potential.

15. The method of claim 11, wherein the generating the second differential clock signal is responsive to a phase locked loop.

16. The method of claim 11, further comprising:
outputting a third differential clock signal dependent on the second differential clock signal; and
generating the third differential clock signal wherein a maximum voltage potential of the third differential clock signal is less than a maximum voltage potential of the first power supply voltage potential, and wherein a minimum voltage potential of the third differential clock signal is greater than a minimum voltage potential of the second power supply voltage potential.

17. The method of claim 16, wherein the generating the third differential clock signal uses an impedance controlled unity gain differential clock driver.

18. The method of claim 16, wherein the generating the third differential clock signal uses a third biased transistor to limit the maximum voltage potential of the third differential clock signal less than the maximum voltage potential of the first power supply voltage potential.

19. The method of claim 16, wherein the generating the third differential clock signal uses a fourth biased transistor to limit the minimum voltage potential of the third differential clock signal greater than the minimum voltage potential of the second power supply voltage potential.

20. An apparatus, comprising:
means for receiving a first power supply voltage potential;
means for receiving a second power supply voltage potential;
means for receiving a first differential clock signal;
means for transmitting a second differential clock signal; and
means for driving the second differential clock signal responsive to the first differential clock signal, wherein a maximum voltage potential of the second differential clock signal is less than a maximum voltage potential of the first power supply voltage potential, and wherein a minimum voltage potential of the second differential clock signal is greater than a minimum voltage potential of the second power supply voltage potential.
